(19) United States
(12) Patent Application Publication
(10) Pub. No.: US 2013/0179337 A1
(43) Pub. Date: Jul. 11, 2013

(54) Account free possession and transfer of electronic money

(71) Applicant: Walter Ochynski, Lawrenceburg, IN (US)

(72) Inventor: Walter Ochynski, Lawrenceburg, IN (US)

(21) Appl. No.: 13/346,068

(22) Filed: Jan. 9, 2012

(51) Int. Cl. G06Q 20/40; G06Q 20/36; G06Q 20/14

(52) U.S. Cl. 705/40; 705/44

(57) ABSTRACT

The account free possession and transfer of electronic money. Payment with E-Money is a settlement free process. Ownership and transfer occurs by means of name (identification number or URL) of the electronic bill and secure password. A person who knows the name and the password owns the money. Upon change of ownership the password has to be changed. The password change occurs on the server and the rest of the process in the individual wallet application or is processed manually by the user of E-Money.

### FIELD OF THE INVENTION

The invention relates to electronic financial assets and transfer of the ownership of these assets. More particularly, the invention relates to electronic money as represented by electronic bills and processing payments by these bills.

### BACKGROUND OF THE INVENTION

Electronic payment transactions have become increasingly important, and tremendous efforts are constantly placed into the development of suitable systems for carrying out such transactions. One such system is the so-called “electronic wallet” or “electronic purse”, which holds sums of money withdrawn from a bank, which can be used to pay for goods and services. The electronic wallet present several problems which, so far, have limited its use: it has a considerable security problem, inasmuch as the loss of the wallet entails the loss of the money it carries, it requires sophisticated storage means, coupled with a “smart card”, as well as complicated and expensive encryption procedures. It further presents a disadvantage that renders it unattractive for many persons, namely, it causes a loss of feeling of control over the money it contains. Since all procedures are automated, encrypted and electronic, with only minimal intervention of the owner, many owners feel that they have no real control over the movement of their money.

Electronic cash has many applications, ranging from the use of electronic wallets carried on the owner, in lieu of credit cards, in daily transactions and including payments for goods and services purchased over the Internet.

The problem of payments over the Internet is well known, and many solutions to it have been suggested. The problem is a complicated one, because the use of credit cards requires that payee install a credit card processing devise, and because in many transactions the buyer does not wish to provide details of himself, or of his bank account.

Also payment with credit cards generates fees in the range of 1.5% to 4%. Payments using debit cards have lower fees but are also less secure.

Among the systems which suggested to overcome this problem, there can be mentioned a few. For instance, PayPal, Brodia, CyberCash, e-cash, eCharqe, InternetCash, iPIN, Qpass, Windows Live ID, WISP, 1ClickCharge. and Flooz.com

PayPal

A Web payment processing service from PayPal, San Jose, Calif. (www.paypal.com). Founded in 1998 and acquired by eBay in late 2002, PayPal operates as an independent brand. Customers with PayPal accounts can pay for merchandise by bank account or credit card on any PayPal merchant site, and their financial data are not revealed to the merchant. Anyone else may use credit cards on PayPal sites; however, their financial data are sent to the merchant.

Brodia

An earlier online shopping and Web payment service from Brodia, San Francisco, Calif. Using preferences, it provided custom searching for merchandise via its shopping portal as well as special offers and discounts. Using customer data stored on its servers, it filled in the order forms. Brodia also offered an e-mail account for contacting merchants and recorded the messages for future review. Brodia ceased operations in late 2001.

CyberCash

A web payment processing service from CyberCash, Inc., Oakland, Calif. that allowed merchants to process credit cards and initiate direct transfers from customer checking accounts. Merchant transactions were sent to CyberCash servers which accessed the credit card networks and Automated Clearing House (ACH). In addition to its back-end payment processing, CyberCash also provided the InstaBuy digital wallet service that fills in the forms at any online shopping site.

One of the earliest (1995) payments systems on the Internet, CyberCash itself ran into financial trouble and declared bankruptcy in early 2001. Its North American payment services operations were quickly acquired by VeriSign, Inc., while its software assets were acquired by First Data Merchant Services Corporation. VeriSign planned to integrate CyberCash's financial processing components and customer base into its own core payment services unit

e-cash

eCash An earlier Web payment service developed in the 1990s by Amsterdam-based DigiCash, Inc. It used a blind signature encryption method and required an active account from an eCash member bank. Digital coins were stored in the eCash Purse digital wallet on the customer's computer, and coins were deducted from the wallet when a purchase was made at eCash-compliant sites. The system was regulated by adding a serial number to each coin. When the merchant received the coins, they were sent to the customer's bank for verification. If a coin matched the serial number of a coin that had already been spent, fraudulent activity was detected. Despite this innovative system, not enough banks participated for its success, and in 1999, eCash Technologies, Inc. acquired DigiCash. In turn, eCash was bought in 2002 by InfoSpace, Inc., Bellevue, Wash. and absorbed into its payment solutions unit.

eCharge

A Web payment service from eCharge Corporation, Seattle, Wash. (www.echarge.com). Initially specializing in digital content and monthly ISP charges, eCharge bills customers via a 900 number on their telephone bills. It later added a revolving line of credit just like a credit card and a prepaid account to support micropayments. Funds can be transferred from the customer's bank via the Automated Clearing House (ACH) system. eCharge uses digital certificates on the user's PC, at the merchant site and at eCharge, and all three are verified before a transaction is completed

InternetCash

A now defunct Web payment service from Spendcash.com, New York that provided a payment method for people without credit cards. Prepaid InternetCash cards were purchased in retail establishments and activated at a participating Web site

iPIN

An earlier Web payment service from iPIN, Belmont, Calif. that specialized in premium digital content billed to third party accounts via Internet service providers (ISPs) and Internet content providers (ICPs). The U.S. company merged in 2003 with Irish technology firm Network 365, and rebranded itself as Valista Ltd. Valista, Dublin, Ireland/San Mateo, Calif. (www.valista.com) operates as a global payments firm that offers online and mobile commerce payment technology. By 2007, the company processed over 20 million payment transactions a month

Qpass

(Qpass Inc., Seattle, Wash., www.qpass.com) A software provider that specializes in managing the full cycle of activities for business systems and value-added data services for wireless carriers and network operators. Its offering includes content partner relationships, authentication, transaction management, access control, billing, settlement and customer care.

Founded in 1997, Qpass started out as a Web payment service in which the Qpass servers contained the digital wallet information necessary to complete purchases. It was the first company to host a full e-commerce system shared by participating merchants that appeared to be part of the merchant's own site. In late 2004, the company acquired Dublin-based Altamedius, a well known European payment provider, in order to be able to offer this service to its mobile commerce clientele

Windows Live ID

A single sign-on and digital wallet service from Microsoft that enables users to quickly log in to Windows Live ID-enabled Web sites and identify themselves. Windows Live ID was formerly known as “Microsoft Passport” and “.NET Passport.”

User IDs, passwords, credit card and shipping and billing information are stored on Microsoft servers, which enables users to make purchases without having to retype the information every time. All Microsoft sites use Windows Live ID as well as some third-party sites.

When users make a purchase on Windows Live ID sites, the merchant sends a request to the Windows Live ID server, which returns the appropriate information. This server-based system supersedes the client-based wallet in earlier versions of Microsoft Internet Explorer.

WISP

An ISP that provides fixed or mobile wireless services to its customers. Using Wi-Fi, WiMAX or proprietary wireless methods, WISPs provide last mile access to rural areas and small villages as well as industrial parks at the edge of town. For example, Clearwire is a WISP that uses WiMAX to deliver the Internet to customers. A Web payment service from Trivnet, Ltd., Tel Aviv, Israel (www.trivnet.com). It specializes in premium digital content that is billed to Internet service provider (ISP), telephone company or credit card accounts. WISP uses patented technology that recognizes you online so there is nothing to download and no password to remember. If the merchant uses the credit card facility, your credit card information has to be entered one time. WISP supports micropayments and charges the account at the end of the month

1ClickCharge

A Web payment service from 1ClickBrands, LLC., New York (www.1clickcharge.com) that specializes in premium digital content and micropayments. Similar to the E-ZPass system for highway tolls, 1ClickCharge requires prepaid deposits charged on a credit card. It also provides complete back-end credit card processing for the merchant without requiring integration to the merchant's Web servers

Flooz.com

Flooz.com was a dot-corn venture, now defunct, based in New York that went online in February 1999, promoted by comic actress Whoopi Goldberg in a series of television advertisements. Started by iVillage co-founder Robert Levitan, the company attempted to establish a currency unique to internet merchants, somewhat similar in concept to airline frequent flier programs or grocery store stamp books. Adoption of flooz by both merchants and customers proved limited, and it never established itself as a widely recognized medium of exchange, which hindered both its usefulness and appeal.

A particular problem is the payment risk inherent in many existing payment systems as offered mostly by banks and the problem of float. Float is the amount of time a payee must wait for a transaction to be processes. All payments which are tied to accounts and use book entry system cannot be totally risk free and anonymous. Currently, paper cash and metal coins provide such privacy in transaction.

Another prior art system is a system with the U.S. Pat. No. 8,051,011

This system is for effecting transactions over a network, comprising at least one isolation server and a first communication device, associated with a first user, connected over the network for communication purposes; a second communication device, associated with a second user, connected over the network for communication purposes; the first communication device and the second communication device are isolatedly connected to one another through said isolation server for the purpose of indirectly exchanging electronic money from the first user to the second user, wherein the first user is provided with money-representing data packets in a first active data packet area located in a first storage area associated with said first user, wherein the money-representing data packets are issued by a Currency Issuing Authority (CIA), a Currency Issuing Authority trusted server (CIAS) programmed to receive an instruction from the first user to pay the second user a first monetary sum and in response to the instruction the CIAS is programmed to (i) delete one or more money-representing data packets in the first active data packets area or (ii) mark one or more money-representing data packets in the first active data packets area as spent; and a data packets database (DPD) associated with the first user comprising money-representing data packets; said CIAS collectively comprising:

a) access to the first user's DPD containing money-representing data packets; and b) software to generate new money-representing data packets and deliver to the second user the new money-representing data packets having a monetary value equal to or less than the first monetary sum. The system with U.S. Pat. No. 8,051,011 requires that the buyer gives instructions to the server to transfer sum from buyer to seller. The server validates the transaction and makes the transfer. Every data packet caries with it an identification that permits server to recognize it, when reaches server again. These data packets are stored on various devises, like disk drive, diskette etc. provided that have to be accessible to the server when needed. Upon payment the used data packets are deleted and removed from the payer and new data packets are transmitted to the payee. Further the system requires that all data be copied onto magnetic, optical or other media, so as to ensure against loss or crashes of the media where the currency is saved. It requires as well that CIAS keeps record of all spent sequences of symbols and does not validate any more payments that relay on spent sequences of symbols. This can result in tremendous record keeping exercise when system is used by many users. The system with U.S. Pat. No. 8,051,011 provides anonymity but it still requires verification whether the data packets (electronic cash) are authentic and that data packages have not been used for payment, by comparing their UIN with a database of previous transaction. In the embodiments of the system that we propose these activities are not required.

Overall the system is quiet cumbersome and also requires special devises to execute payment with the electronic purse when it is being used in a physical store. The system with the U.S. Pat. No. 8,051,011 claims a method of money transfer that does not resemble the physical flow of cash. The system with the U.S. Pat. No. 8,051,011 claims a system where the electronic money is deleted or marked as spent upon every transfer. This process promotes the idea that the money being transferred has ownership of a user or has a specific status. In the physical world, the users have ownership of money and the money does not in anyway have a status (the money can not be “deleted” nor can it be marked as “spent”). Simply put, the system with the U.S. Pat. No. 8,051,011 does not achieve a real world money transfer system, and therefore complicates the payment process as well as making the system unfavorable to a user who wishes to use his electronic money the same way he uses his physical money.

Similarly in the system with the U.S. Pat. No. 5,983,207 it is necessary to check whether the particular coin has not been previously spent and if not to create a new coin and transmit it to the new owner. Again these are burdensome procedures which with the here proposed system are avoided.

In the issued U.S. Pat. No. 5,913,203, a system is suggested, which is stated to provide totally anonymous or effectively anonymous cash-like transactions, which are accomplished by using a pseudo cash data package converter for inserting a user key into a pseudo cash preliminary data packet through the use of a user insertion key to generate a pseudo cash unit with a fixed monetary value that can be used to purchase goods or services via the Internet. A pseudo cash repository facilitates the cash-like transactions and maintains a record of the pseudo cash units and their fixed monetary value. Depending upon the level of anonymity selected by a purchaser, the pseudo cash repository can either transmit pseudo cash preliminary data packets or pseudo cash units to a first entity. If the first entity loses an effectively anonymous pseudo cash preliminary data packet, it can be replaced by the pseudo cash repository without risk of loss.

This patent is said to solve one of the prior art problems existing, e.g., in the Digicash system, in which a user's ecash is stored as a series of numbers on the hard disk of his PC. This leads to the danger that, if one has a disk crash, or if one's computer is stolen, one has lost his money.

Recently a new system was proposed called Bitcoin.

Bitcoin is a decentralized, peer-to-peer network over which users make transactions that are tracked and verified through this network. The word Bitcoin also refers to the digital currency implemented as the currency medium for user transactions over this network. In addition, the name Bitcoin refers to the client software allowing access to this network for conducting transactions.

To track and verify user transactions Bitcoin implements a type of triple-entry accounting system. To maintain a uniform transaction record in this accounting system a “proof-of-work” computer-code algorithm is used as the basis for a user-transaction journaling process that allows a large group of computers across the network to agree on a single consistent currency transaction account ledger without centralized coordination. The design allows the transaction process to work over differences in timing, a varying number of participants, even varying levels of honesty, and differences in perspective among the individual participants. There a limited number of bitcoins, approximately 21 million, thereof up to now approximately 7 million are used. To avoid double spending all transactions are “duplicated” on all participating computers, and any new transaction has to refer to all previous transaction and required computational effort is enormous. It involves also some time before a transaction is processed.

A disadvantage of most of the described systems is that they require public/private key encryption methods. This means that anybody who wants to participate in the payment process needs to acquire the public key of the emitting agency.

Because, of these facts, there is currently no electronic “currency” that can be used in a simple manner by the general public as well as by Internet surfers, banks, central banks just as one uses bills, coins or checks. It is therefore clear that there is a great need for an electronic currency that overcomes the disadvantages of the prior art. Any system which is based on credit or debit cards even new developments like PayWave and PayPass—provided by Visa and MasterCard are not offering any reduction in fees for vendors accepting these payments.

Additionally, most of the prior art systems require the user to open an account with either a bank, or a pseudo-bank, or with a supplier, and either to provide prepaid funds to these accounts, from which it possible to draw, or to perform relatively complicated operations when the user wishes to spend, withdraw or generate funds.

The reliance on encryption, especially public key encryption, whether based in software or hardware comes at a price: the greater the use of encryption, the greater the processing effort required to decrypt messages. On the other hand Internet offers secure communication when secure protocol is used. However most of the prior art systems do not use this feature.

Another severe drawback of certain systems is that they require that the cash dispenser be involved in the transaction, to identify the users (either the buyer, the seller, or both), rendering the transaction cumbersome, and detracting from its privacy.

Because, of these facts, there is currently no electronic “currency” that can be used in a simple manner by the general public in physical transactions or when surfing the Internet, just as one uses bills, coins or checks.

It is therefore clear that it would be highly desirable to provide an electronic currency system which is free from all the aforementioned drawbacks. It is therefore an object of here proposed system to provide electronic currency and a system for its implementation, that overcome all the aforementioned drawbacks of the prior art.

It is a further purpose of the invention to provide an electronic currency and system which are user-independent, and which do not require a user key or identification and without a necessity to copy electronic currency to other media, so as to ensure against loss or crashes of the media where the currency is saved.

It is a further purpose of the invention to provide an electronic currency and system which does not require any additional encryption procedure and is not coupled with any “smart card”.

It is a further purpose of the invention to provide an electronic currency and system which does not use any blind signature encryption and does not require any active account.

It is a further purpose of the invention to provide an electronic currency and system where everybody can participate without any preconditions like for example knowledge of the public key.

It is still another object of the invention to provide a method and system which can be used for any currency and other financial assets, stock, bonds, gold, etc. In case the asset is currying interest or dividend this should be supported by the system as well.

It is a further object of invention to offer a system which is float free, without any counterparty risk and if the said system would be offered by central banks could lead to 24/7 instantaneous settlement.

It is a further object of the invention to provide a method and currency which can be used for restricted payments to specific individuals.

These and other deficiencies in the prior art are addressed by the present invention.

Other purposes and advantages of this invention will appear as the description proceeds.

### SUMMARY OF THE INVENTION

This is an account free transfer system which gives possession of electronic bills and resembles payment with physical cash. The system is a bearer digital cash system, meaning that someone who holds an electronic bill is considered to be its lawful owner.

The E-Money exists in different denominations of electronic bills. It will never leave the secure server on which it is created and stored. E-Money ownership is identified by the bill name and password. The issuer of the proposed system does not create more electronic bills than the amount of cash deposited.

The owner's wallet application keeps record of electronic bills and handles receipt and spending of electronic bills.

The concept behind E-Money is that a person who knows the name of a bill and its password is considered the lawful owner of that bill. Therefore, the owner can change the password at any time to secure his/her ownership.

The combination of the E-Money and its corresponding Wallet application empowers consumers to make transactions at any time, to anyone, from anywhere with their smart phone or computer. Additionally, stores can collect all their proceeds without any credit or debit card discounts and banks can execute their transfers 24/7.

### DETAILED DESCRIPTION OF PREFERRED EMBODIMENTS

The account free possession and transfer of electronic money. Payment with E-Money is a settlement free process. Ownership and transfer occurs by means of name (identification number or URL) and secure password. A person who knows the name and password owns the money. Upon change of the ownership the password has to be changed. The change of the password occurs on the server and the rest of the process in the wallet application or is processed manually by the owner of E-Bills. The wallet application can be located on the server or on smart phone or personal computer.

E-Money exists on the server and the possession/ownership is identified by the name and the password.

The owner of cash has the physical ownership. The cash is in his wallet, pocket, his hand or in some place which belongs to him like save room, drawer etc. E-Money does not exist outside the computer. E-Money will never leave the server on which it will be created and stored. Only the identification of the electronic banknote and the password will be passed from owner to owner. They together identify the owner. The owner can always pass the ownership to his electronic bill to somebody else by giving him the name of the bill and password. Upon receipt of E-Money the new owner has to change the password to protect his ownership. The E-Money is comparable to cash; one claims the ownership from physical ownership (here name and password) and not from any account statement. Payment with E-Money is a settlement free process without necessity of any book entries.

The System:

To operate E-Money we would need a server, where E-Bills are stored. The server has to belong to a trustworthy entity to ensure that only valid E-Bills are created. E-Bills are like cash deposited in a bank. The trustworthy institution has the fiduciary responsibility not to create more E-Bills, than cash deposited with it. As long E-money is created through conversion of cash, for example, sight deposits, the overall money supply is not increased and price stability is not endangered. To profit from seigniorage is not an objective of E-Money system. The server can be accessed by any devise connected to internet (PC, tablet, smart phone etc.) Any user can download an application to facilitate the process or use the application stored on the server. This application called wallet will keep record of amount of E-Bills and handle receipt and spending of E-Bills. The server will not prepare any account statements showing the owner of E-Bills. Privacy has the absolute priority. The concept does not use any “asymmetric key cryptography” this means is not using any algorithms that has the public key/private key property.

The system is comprised of the server and wallet to facilitate possession and transfer of E-bills and a trustworthy entity to ensure that no more E-Bills are created than cash obtained.

The Process on the Server:

E-Money will be created upon receipt of cash. New E-Money bills will be created in the denominations required by the customer. When money is transferred the wallet application will automatically create the necessary denominations to facilitate the payment process. Information about a user's money will show up in the wallet application. The password will be a strong password created using the random number generator. Therefore the passwords are practically unbreakable. The tamper-resistant process will be applied to hinder fraudulent users to access E-Bills that they don't own. Each bill can contain the following information: ID—what will be also part of the URL, if URL is used Denomination—$1, $5, $10, $20, $50, $100, $1000 etc. or any other currency, gold, shares, bonds, etc.

Password.

This information is presented in this form only for user convenience; this is redundant information (ID, denomination, password) and can be stored in the computer as one variable. More information needs to be stored when E-Bills carry interest, like interest rate, starting and due date, etc., or represent shares or bonds.

Additional information will be stored in the wallet and history database:

The user's email address or mobile phone number if transferred through email, recipient's email or mobile phone number if transferred trough email IP address of the access point and location of the access point and date.

The user can always trigger the change of the password. This normally will happen automatically upon transfer of the E-Bills to the new owner, however the password can also be changed anytime.

The information of previous owners email addresses, IP addresses etc. will be stored for some time. This information could be used in case of dispute or fraud. Keeping in mind that privacy is a basic human right this information will not be kept for any other purposes than to clear disputes and avoid fraud and will be purged when this objective is fulfilled. Transferring E-bills by email exposes information to possible onlookers. Therefore this process will be used only for small amounts and first time payments. When beneficiary has already wallet application installed on his smart phone or PC or is a registered user of the wallet application running on the server the email will only inform him that he has received a transfer, which he can check with his wallet application.

The Process in the wallet:

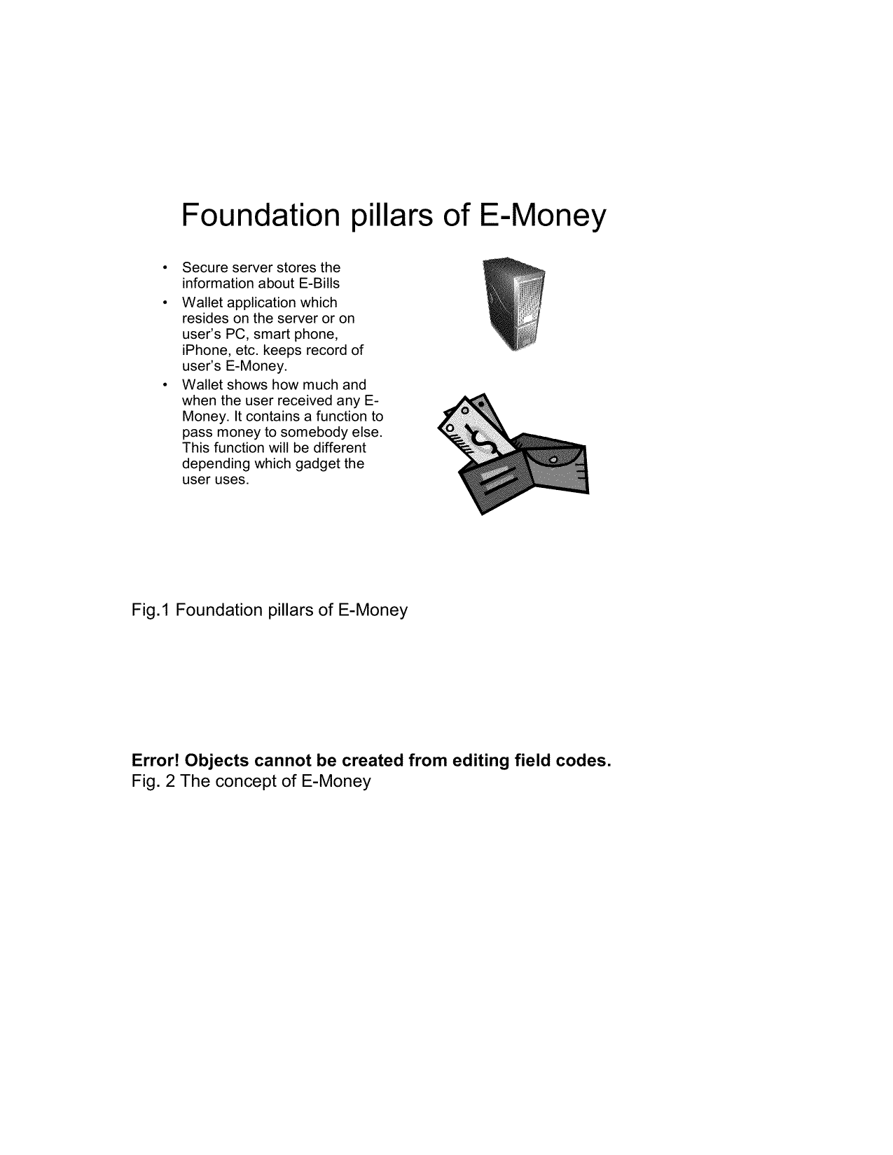

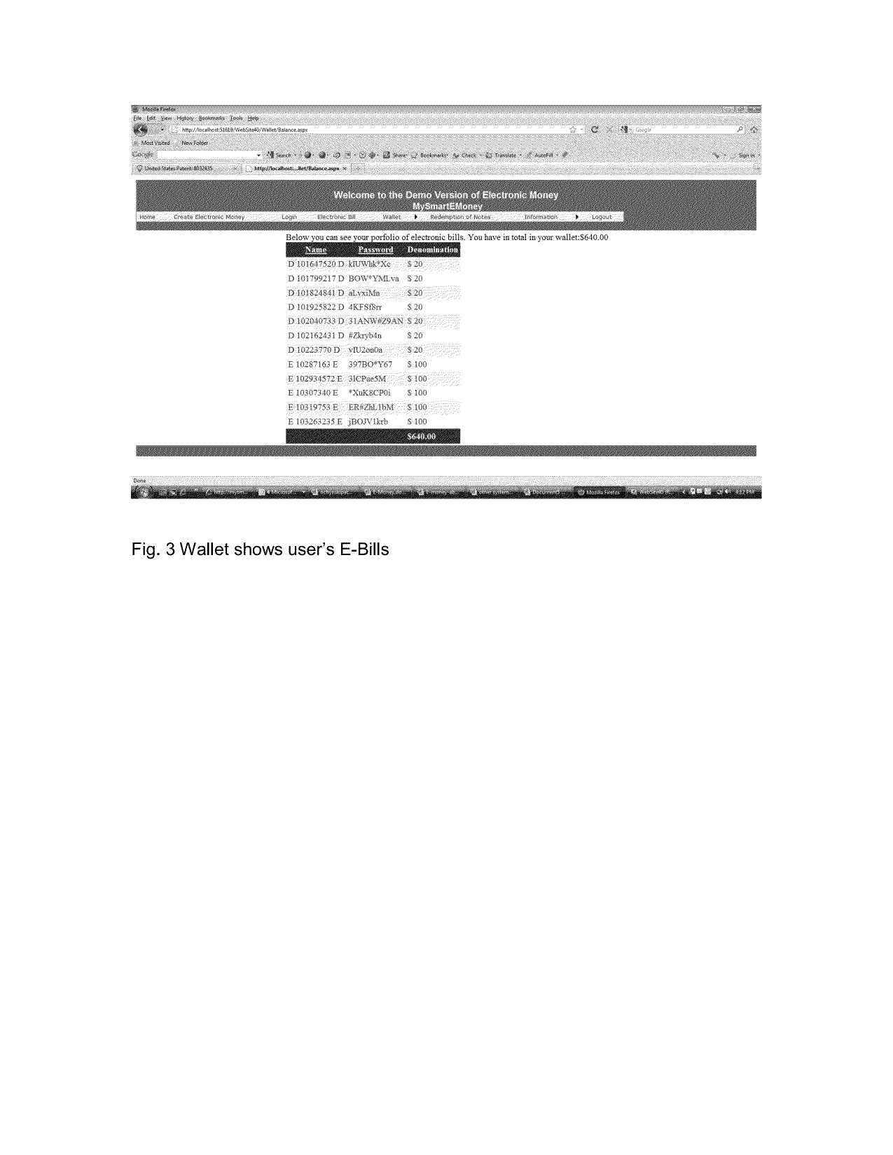

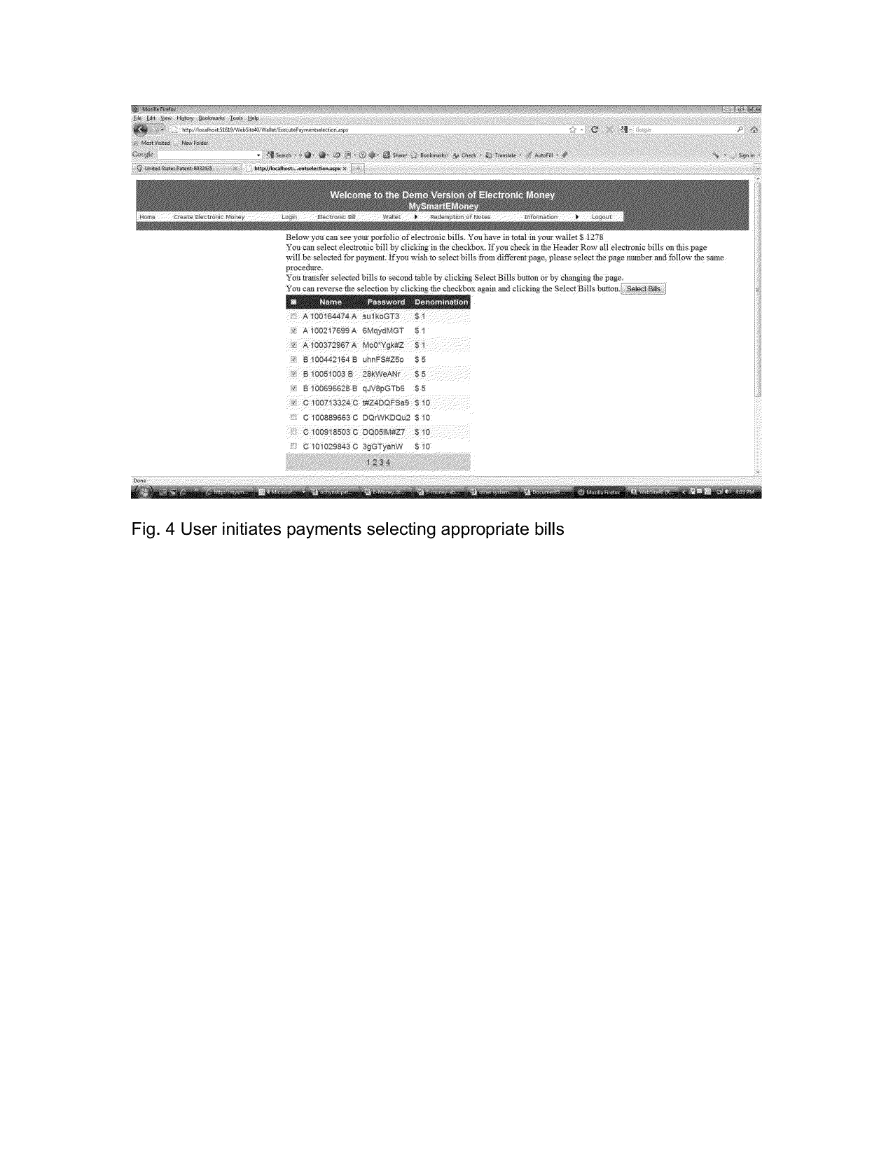

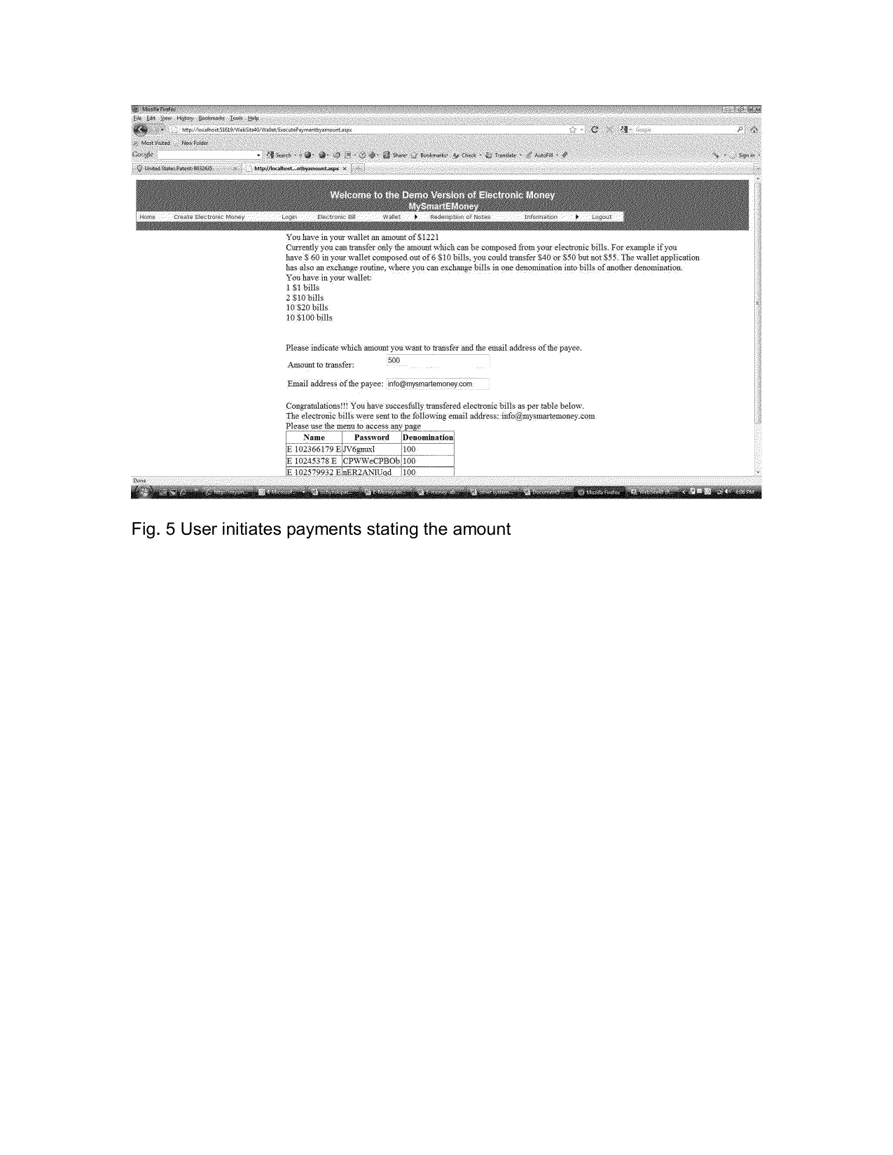

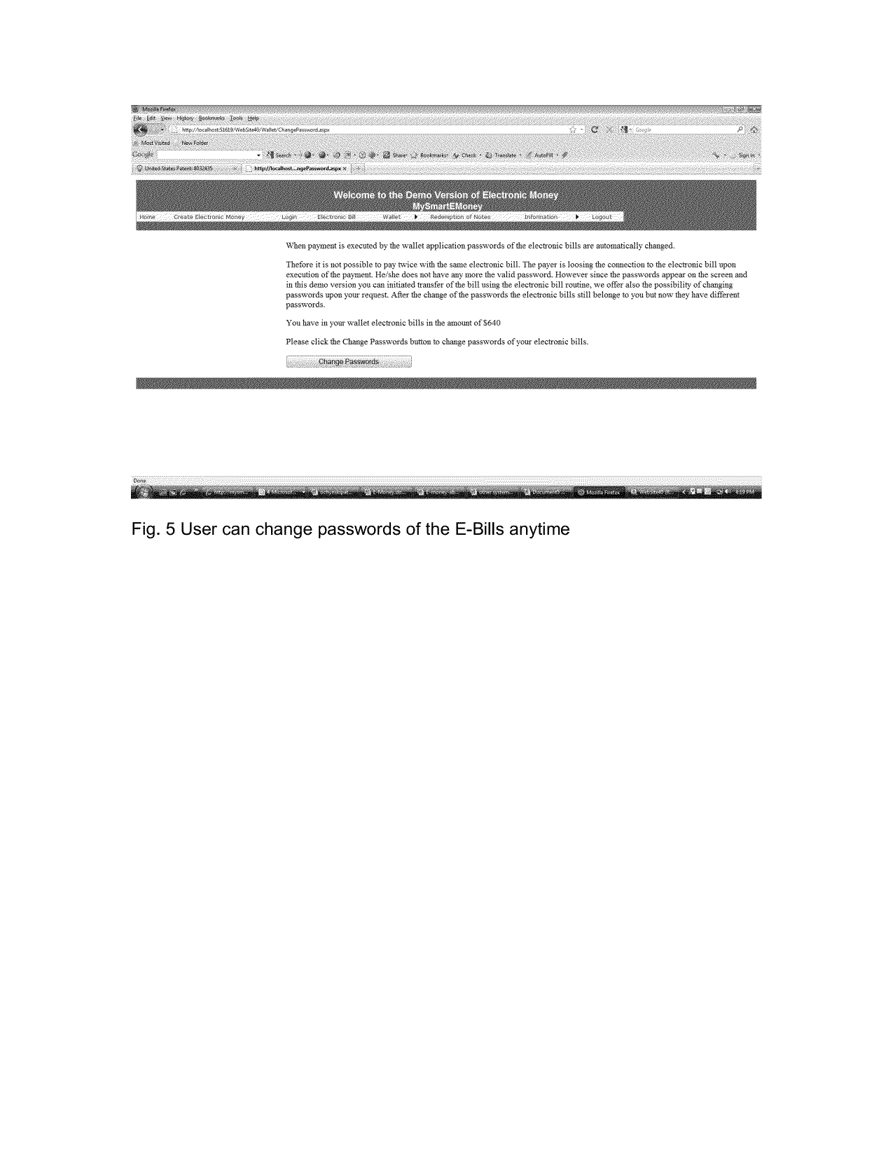

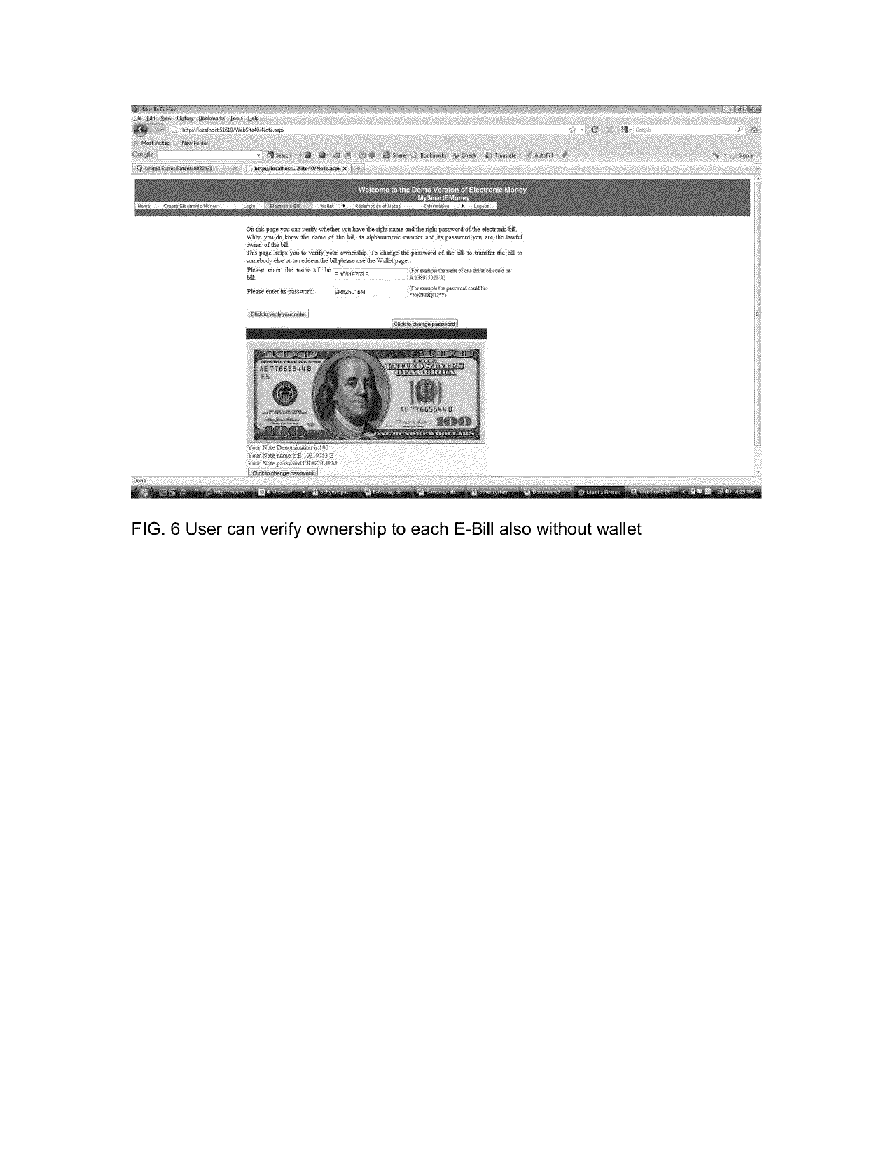

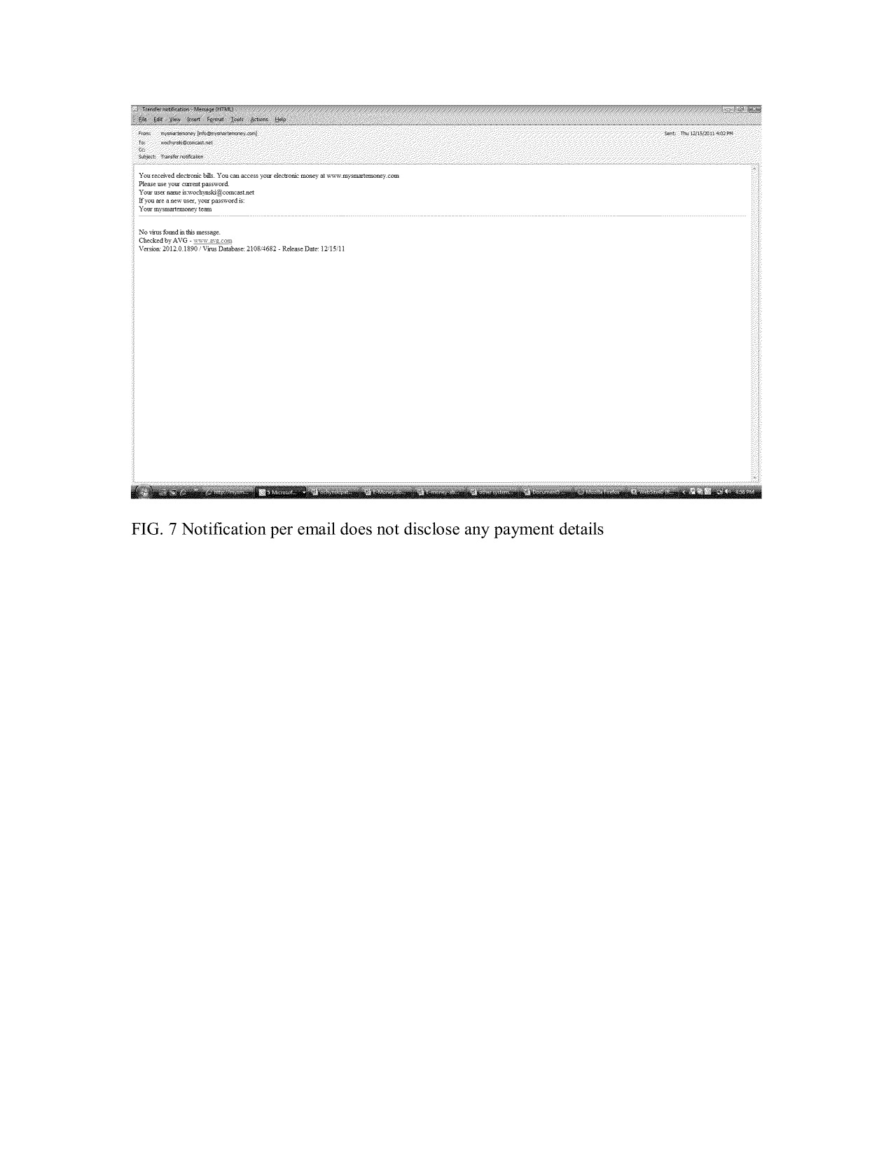

Each user of the E-Money will use an application called wallet to facilitate the process. There will be separate applications for PC, for smart phones and tablets. Wallet will show the user how much E-Money he/she posses, FIG. 3. Wallet will show when new payments arrive and how much. The wallet will also contain the function to pass money to somebody else, FIG. 4. This function will be different depending which gadget the user uses, for example wallet for smart phones will support NFC (Near field Communication) and payment creating appropriated bar code. Wallet will have also a function to change passwords of the E-Bills. User will have the possibility to change the password automatically upon receipt of E-Bills. Passwords of bills involved will be automatically changed, when payments are initiated with the wallet of the payer. Wallet will support also acquisition of new E-Bills against cash transfer and redemption of E-Bills. User will have E-Bills in certain denomination. When required payment cannot be composed from available E-Bills, for example the user has one $20 bill and wants to transfer $15, then system will propose to automatically exchange a $20 bill for let say one $10 bill and two $5 bills and then execute the required payment amount. After the payment the payer in this example will have one $5 bill in his wallet.

To access server wallet application the user will have the possibility to use RSA SecurID token, procedure which is now offered/required by many banks or multinational companies to access their virtual networks. The E-Bills are stored on secure server, however wallet application will also check the IP address of the server to assure that wallet is connected to the right server and not rely solely on secure transfer protocol. As described the system is not using any encryption, public/private key signature, etc. but just relies on the standard encryption procedures included in any major browser when secure connection is established (https protocol).

Description of the process from creation to redemption of E-Bills

New E-Bills: When somebody needs E-Bills he/she will be able to contact the participating bank or E-Money Center per email, instant message, text message etc. requesting E-Bills in certain denomination. E-Money Center or wallet application will inform the new user where and how to transfer cash which can be exchanged for E-Bills. E-Money Center/Wallet will provide the banking information (ABA code and account number) or PO Box where to send check. The charge to credit or debit card will be also accepted however costs will be charged back to the user. Upon receipt of funds E-Money Center will issue new E-Bills and a user will be able to verify the receipt of E-Money with his wallet application. When initializing the wallet application the user will choose name (“email address”) for his wallet, then wallet can manage the receipt and transfers/payments automatically, otherwise E-Bills can always be sent to a valid email address and “dropped” to the wallet manually.

Payment with E-Bills: Now knowing the name and password of the E-Bills the user can pass the ownership to his E-Bills to anybody by handing out information about the name and password. Again the process can be executed with or without wallet. Practically everybody will use wallet application. The new owner has to change the password to ensure that nobody else can claim the ownership to his/her E-Bills. You can pay with E-Bills without providing any email address just by passing a name and the password. Wallet only facilitates the process but is not a requirement.

Redemption of E-Bills: When the owner of the E-Bills wants to exchange the E-Bills for cash he can use the wallet application or contact E-Money Center by email and inform E-Money Center where cash should be transferred, check to be mailed, or which credit/debit/gift card should be credited.

E-Money does not need any account to function because each E-Bill is in principal an account in itself and there is no need to book entries into account but only to keep “possession” into the bills, which will be facilitated with the wallet applications.

The transfer of the E-Money will not cost anything except for certified or registered transfers, where a user requests that the new possession can only be taken by a user with predefined email address.

Therefore there will be a tremendous incentive for the seller to use this medium versus payment by paypal, credit and debit cards. Only when the user wants to exchange E-money for cash a small handling fee will be charged. Otherwise E-Money will finance itself by the float and advertisement. The owner will be able to exclude any advertisement by purchasing advertisement free wallet application. E-Money is a bearer digital cash as US dollar in paper form is a bearer instrument. That is, the person who holds it is normally considered to be its lawful owner. There is no list of owners of paper currency (a registration record); ownership is conveyed by physical possession. The same applies to E-Money. The advantage of bearer instrument transactions is that settlement is in real time, and therefore there is no risk of non-payment, as there is in book entry transactions such as checks, bank transfers and credit cards. There are no charge backs to the merchant, and the risk of fraud is greatly reduced. Bearer instruments are also anonymous, which can protect the owner.

In another embodiment E-Bills can pay interest. In case E-Money pays interest then on due date new E-Bills representing interest will be created. The names of these E-Bills will be derived from E-Bills representing the principal and their passwords will be the same as password of original E-Bills as on due date. The interest amount will be rounded down to the lowest denomination of available E-Bills. Wallet application will automatically check for any available and due interest.

In another embodiment of the invention E-Bills are not denominated in US dollars but in any valid currency.

Fraud:

According to another embodiment of present invention to further reduce possible fraud the owner will be able to execute certified transfer. This kind of transfer will require a payment of a small fee. The change of the password will be restricted to an email address as pre-defined by the user and the process will be facilitated by the wallet application as well.

Even if a password of the E-Bill is compromised this affects only this one particular E-Bill, other E-Bills are not exposed because they carry different passwords. This is a tremendous security improvement versus payment for example with credit or debit card. It has to be emphasized that system does not require any encryption apart from standard encryption which is used by all major browsers during secure internet connection. This is an unquestionable advantage of the system.

Another preferred embodiment will support all electronic information distributions, for examples shares, bonds, gold, securitized investments, bill of lading etc. Any financial assets can be represented in the electronic form with its name and password, where password is used to claim and change the ownership.

In one embodiment of the invention, when the system is applied by a central bank, E-Money could offer risk free instantaneous 24/7 settlement.

The description of the invention does not necessarily describe all necessary features of the present invention. The present invention may also be a sub-combination of the features described above.

I claim:

1. A system capable of representing electronic money using unique, identifiable, and potentially variable parameters, where knowledge of said parameters indicates ownership of the electronic money.

2. The system described in claim 1 wherein said parameters are comprised of a name, which can also be expressed as a URL, and a password.

3. The system described in claim 1 wherein said electronic money is stored on a secure server that the owner of said electronic money can connect to through a secure internet connection.

4. The system described in claim 1 and claim 2 wherein a means for changing said password enables the ownership of the electronic money to change.

5. The system described in claim 1 wherein a trustworthy issuer guarantees the redemption of said electronic money.

6. An application (Wallet) which provides means for keeping records of electronic bills and means for facilitating receipt and transfer of said electronic bills.

7. The application described in claim 6, whereby said application may be located on several mediums including but not limited to said server or decentrally on a user's PC, tablet or smart phone.

8. The system described in claim 1 and claim 6 where said electronic money is made up of said electronic bills (E-Bills) which will be issued in various denominations and will be stored on said secure server connected to the internet through https protocol.

9. The system described in claim 1 and claim 6 where ownership of said E-Bills is determined by knowledge of the E-Bill's name and password.

10. A system in accordance with claim 1 and claim 6 where said electronic money is substituted by other financial asset, for example, stock, bond, debenture, gold, etc.

11. A system in accordance with claim 1 and claim 6 where said electronic money is substituted by any valuable commodity.

12. A system in accordance with claim 1 and claim 6 where said electronic money is any valid currency and not only US Dollar.

13. A system in accordance with claim 1 and claim 6 where said electronic money bears interest and when interest is due new E-Bills will be created, which names are derived from the E-Bill being a principle and the password is the same as the password of the said principle E-Bill at the interest due date.

14. A system in accordance with claim 1 and claim 6 where new E-Bills will be automatically created in exchange for E-Bills of higher denomination to facilitate desired payments

15. A system in accordance with claim 1 and claim 6 where payment is executed not only to one but many recipients.

16. A system in accordance with claim 1 and claim 6 with additional security measures to restrict potential new owners of E-Bills to defined payees.
